(19) United States
(12) Patent Application Publication
(10) Pub. No.: US 2025/0178214 A1
(43) Pub. Date: Jun. 5, 2025

(54) BRACKET, ROBOT, WELDING DEVICE, AND ROBOT SYSTEM

(71) Applicant: FANUC CORPORATION, Minamitsuru-gun, Yamanashi (JP)

(72) Inventor: Yuuki TAJIMA, Yamanashi (JP)

(73) Assignee: FANUC CORPORATION, Minamitsuru-gun, Yamanashi (JP)

(21) Appl. No.: 18/836,827

(22) PCT Filed: Mar. 30, 2022
(86) PCT No.: PCT/JP2022/016137

§ 371 Date: Aug. 8, 2024

(51) Int. Cl. B25J 15/04; B25J 11/00

(52) U.S. Cl. CPC B25J 15/045; B25J 11/005

(57) ABSTRACT

A bracket that includes a bracket body that is attached to a tool attachment surface of an arm member with an insulating plate therebetween, insulation members that electrically insulate bracket fixing implements and fix the bracket body to the tool attachment surface from the inside and the bracket body from each other, and an insulating cover that has electrical insulation properties and that is disposed inside the bracket body. Each of the bracket body, the insulating plate, and the insulating cover has a hollow hole through which an umbilical member is passed into an interior of the bracket body from inside the arm member. The bracket fixing implements include bolts that are fastened to screw holes in the tool attachment surface. The insulating cover covers a gap between the hollow hole of the bracket body and the umbilical member and is fixed to the bracket body by the bolts.

### TECHNICAL FIELD

The present invention relates to a bracket, a robot, a welding device, and a robot system.

### BACKGROUND

An industrial robot for uses such as welding is provided with an insulation structure that electrically insulates a tool and a robot body from each other in order to prevent a current from flowing into the robot body from the tool (for example, Japanese Unexamined Patent Application, Publication No. Sho 62-142083, Japanese Unexamined Patent Application, Publication No. 2013-202697, and Japanese Unexamined Patent Application, Publication No. Hei 11-114873). In the case of Japanese Unexamined Patent Application, Publication No. Sho 62-142083, an insulation member is disposed between a robot body and a tool. In the case of Japanese Unexamined Patent Application, Publication No. 2013-202697 and Japanese Unexamined Patent Application, Publication No. Hei 11-114873, a disc-shaped insulation member is disposed between a reducer at a distal-end portion of a robot body and a wrist flange, and insulating washers and insulating collars are disposed between the wrist flange and bolts that fix the wrist flange to the robot body.

Meanwhile, there are cases in which a bracket having a hollow structure is used when attaching a tool to a tool attachment surface of a hollow arm member (for example, see Publication of Japanese Patent No. 5344315 and Japanese Unexamined Patent Application, Publication No. Hei 08-047886). An opening is provided in the tool attachment surface of the hollow arm member in order to pull out an umbilical member from the interior of the arm member. In the case in which a tool that does not have a hollow structure is directly attached to the tool attachment surface, the opening is closed off by the tool and the umbilical member cannot be pulled out. By using a bracket having a hollow structure, the tool that does not have a hollow structure can be attached to the tool attachment surface. Specifically, the tool that does not have a hollow structure is attached to the tool attachment surface separated therefrom by the bracket and the umbilical member is routed to the tool from the opening via the interior of the bracket.

### SUMMARY

An aspect of the present disclosure is a bracket including: a bracket body that has a hollow structure and that is attached to a tool attachment surface of a hollow arm member with an insulating plate having electrical insulation properties interposed therebetween; insulation members that electrically insulate bracket fixing implements, which fix the bracket body to the tool attachment surface from inside the bracket body, and the bracket body from each other; and an insulating cover that has electrical insulation properties and that is disposed inside the bracket body, wherein each of the bracket body, the insulating plate, and the insulating cover has a hollow hole through which an umbilical member passes into an interior of the bracket body from inside the arm member via an opening of the tool attachment surface, the bracket fixing implements include one or more bolts that are fastened to screw holes provided in the tool attachment surface by passing through through-holes provided in each of the bracket body, the insulating plate, and the insulating cover, and the insulating cover covers a gap between the hollow hole of the bracket body and the umbilical member and is fixed to the bracket body by fastening the bolts.

### BRIEF DESCRIPTION OF DRAWINGS

FIG. 1 is an overall configuration diagram of a robot according to an embodiment of the present disclosure.

FIG. 2 is a side view of a bracket according to the embodiment of the present disclosure, attached to a tool attachment surface of a robot body.

FIG. 3 is a longitudinal cross-sectional view showing a bracket body of the bracket in FIG. 2.

FIG. 4 is a lateral cross-sectional view of the bracket taken along the line I-I in FIG. 2.

FIG. 5 is a partial longitudinal cross-sectional view of the bracket taken along the line II-II in FIG. 4.

FIG. 6 is a partial longitudinal cross-sectional view showing a modification of the bracket.

FIG. 7 is a partial longitudinal cross-sectional view showing another modification of the bracket.

FIG. 8 is a partial longitudinal cross-sectional view showing another modification of the bracket.

FIG. 9 is a partial longitudinal cross-sectional view showing another modification of the bracket.

FIG. 10 is a partial longitudinal cross-sectional view showing another modification of the bracket.

FIG. 11 is a partial longitudinal cross-sectional view showing another modification of the bracket.

FIG. 12 is a partial longitudinal cross-sectional view showing another modification of the bracket.

FIG. 13 is a partial longitudinal cross-sectional view showing another modification of the bracket.

FIG. 14 is a front view of a clamp provided in the bracket in FIG. 13.

### DETAILED DESCRIPTION OF EMBODIMENTS

A bracket 1, a robot 20, a welding device, and a robot system according to an embodiment of the present disclosure will be described below with reference to the drawings.

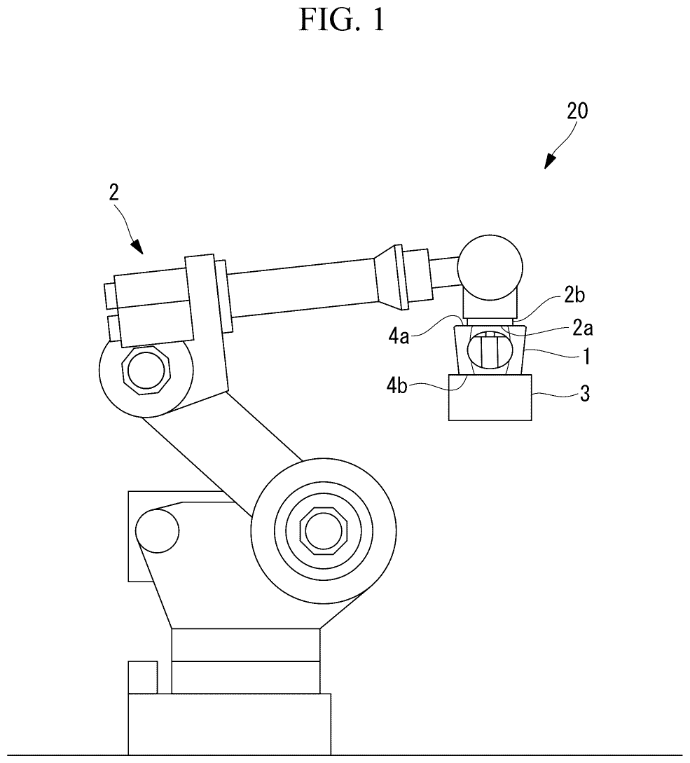

As shown in FIG. 1, the robot 20 is an industrial robot including a robot body 2 and the bracket 1, which has a hollow structure and which can be attached to a tool attachment surface 2a of the robot body 2.

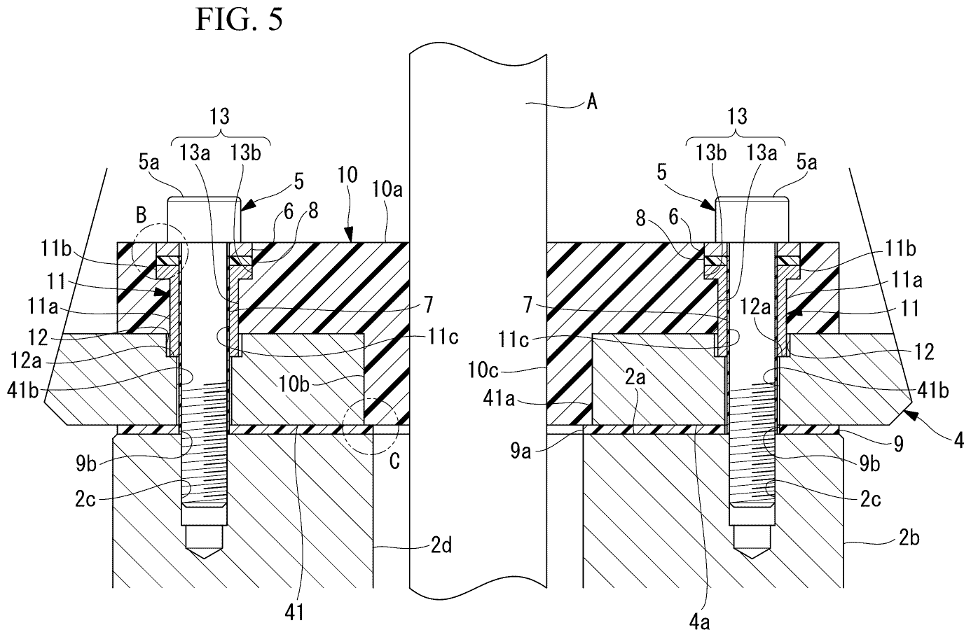

The robot body 2 has at least one arm member. A distal-end surface of an arm member 2b at the most distal end of the robot body 2 serves as the tool attachment surface 2a to which a tool 3 or the bracket 1 is attached. The tool attachment surface 2a is provided with a plurality of screw holes 2c (see FIG. 5) for bolts (bracket fixing implements) 5 that fix the tool 3 or the bracket 1 to the tool attachment surface 2a.

The arm member 2b at the most distal end is hollow, and a hollow portion 2d (see FIG. 5) in the arm member 2b is provided with an opening in the tool attachment surface 2a. For example, in the case in which the robot body 2 is a six-axis vertical articulated-type robot, the arm member 2b is a cylindrical member that rotates about a sixth axis. An umbilical member A that supplies power and signals, etc. to the tool 3 is routed inside the hollow portion 2d, and the umbilical member A is pulled out to the exterior of the arm member 2b from the opening in the tool attachment surface 2a.

In the case in which a tool 3 that does not have a hollow structure is directly attached to the tool attachment surface 2a, the opening of the hollow portion 2d is closed off by the tool 3, and the umbilical member A cannot be pulled out from the hollow portion 2d. Therefore, a tool 3 that does not have a hollow structure cannot be directly attached to the tool attachment surface 2a. The bracket 1 makes it possible to attach a tool 3 that does not have a hollow structure to the tool attachment surface 2a. The bracket 1 may be provided as part of the robot system including the robot 20 and the tool 3.

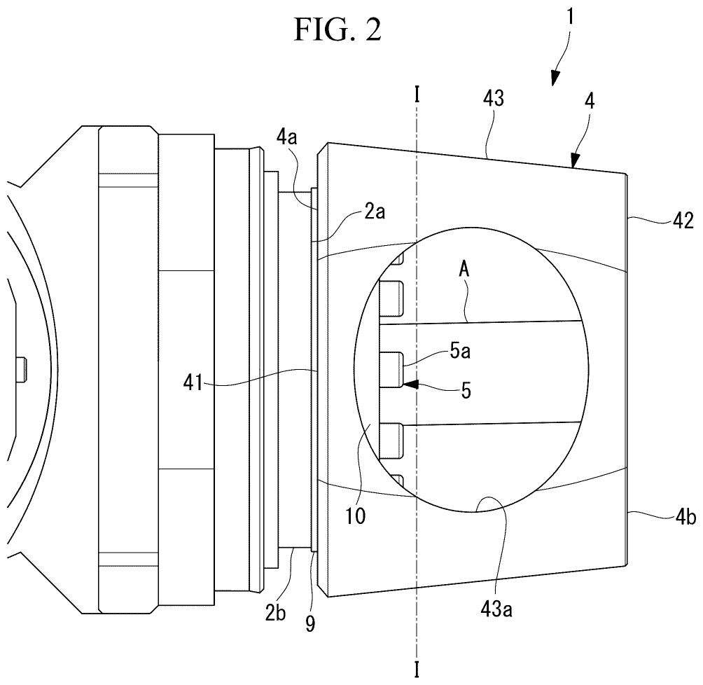

As shown in FIGS. 2 to 5, the bracket 1 includes: a bracket body 4 that is fixed to the tool attachment surface 2a by the bracket fixing implements; insulation members; an insulating cover 10; and collars 11.

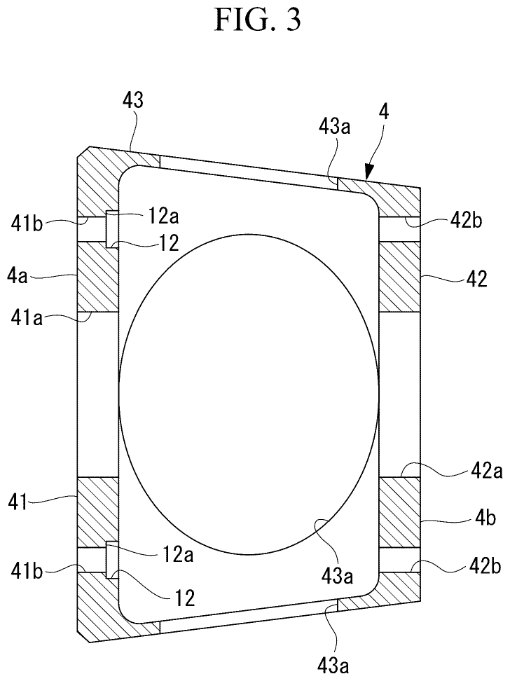

As shown in FIG. 3, the bracket body 4 is a box-shaped member that has a hollow structure and that is formed from a conductive metal material and has a flat plate-like basal-end wall 41 and a flat plate-like distal-end wall 42 that are disposed parallel to each other with a spacing therebetween and a cylindrical side wall 43 that connects the basal-end wall 41 and the distal-end wall 42.

An outer surface of the basal-end wall 41 is provided with a robot attachment surface 4a that is fixed to the tool attachment surface 2a of the arm member 2b with an insulating plate 9 having electrical insulation properties sandwiched therebetween. In addition, an outer surface of the distal-end wall 42 disposed on the opposite side from the tool attachment surface 2a is provided with a tool attachment surface 4b to which the tool 3 is attached.

The basal-end wall 41 has a hollow hole 41a that extends through the basal-end wall 41 in the thickness direction at a position facing the opening of the hollow portion 2d when the bracket body 4 is attached to the tool attachment surface 2a of the arm member 2b. In addition, the basal-end wall 41 has, in an area surrounding the hollow hole 41a, a plurality of through-holes 41b that extend through the basal-end wall 41 in the thickness direction.

The respective through-holes 41b are provided at positions that correspond to the screw holes 2c of the tool attachment surface 2a when the bracket body 4 is attached to the tool attachment surface 2a of the arm member 2b. Each of the through-holes 41b is provided with a counterbore 12 having a prescribed depth from an inner surface of the bracket body 4.

The insulating plate 9 is formed in an annular shape and is provided with a hollow hole 9a that extends therethrough in the thickness direction at a center position facing the opening of the hollow portion 2d when the insulating plate 9 is disposed at the tool attachment surface 2a of the arm member 2b, as shown in FIG. 5. In addition, the insulating plate 9 includes, in an area surrounding the hollow hole 9a, a plurality of through-holes 9b that extend therethrough in the thickness direction. The through-holes 9b are provided at positions that correspond to the screw holes 2c when the insulating plate 9 is disposed at the tool attachment surface 2a of the arm member 2b.

Accordingly, when the bracket body 4 is attached to the tool attachment surface 2a of the arm member 2b with the insulating plate 9 sandwiched therebetween, an internal space of the bracket body 4 and the hollow portion 2d of the arm member 2b are in communication with each other via the hollow holes 9a and 41a. The umbilical member A is routed into the interior of the bracket body 4 by passing through the hollow holes 9a and 41a from the opening of the hollow portion 2d. The insulating plate 9 may be provided as part of the robot body 2 or part of the bracket 1.

The distal-end wall 42 may include: a window 42a that extends through the distal-end wall 42 in the thickness direction and through which the umbilical member A can pass; and screw holes 42b for fixing the tool 3. In the case in which the tool 3 has a hollow structure, the umbilical member A is connected to, via the window 42a, the tool 3 attached to the tool attachment surface 4b.

The side wall 43 has at least one window 43a that extends through the side wall 43 in the thickness direction and through which the umbilical member A can pass. In the case in which the tool 3 does not have a hollow structure, the umbilical member A is pulled out to the exterior of the bracket 1 via the window 43a to be connected to the tool 3.

The bracket fixing implements include a plurality of bolts 5 that are fastened to the screw holes 2c of the tool attachment surface 2a. The bracket fixing implements may include, as needed, metal washers 6 that are used together with the respective bolts 5. The bolts 5 and the metal washers 6 are formed from a high strength material, for example, steel.

The insulation members are formed from a material having electrical insulation properties, such as a resin, and each includes a cylindrical insulating sleeve 7 and an annular plate-shaped insulating washer 8. The insulating sleeve 7 and the insulating washer 8 include inner holes through which the bolt 5 passes.

The insulating sleeve 7 covers an outer circumferential surface of the bolt 5 positioned between the insulating washer 8 and the insulating plate 9. The insulating washer 8 has, for example, outer diameter and inner diameter dimensions that are the same as those of the metal washer 6.

The collars 11 are formed from a high-strength material, for example, steel. The collars 11 each have an inner hole 11c through which the bolt 5 covered with the insulating sleeve 7 passes and has a small-diameter portion 11a that has a certain outer diameter dimension and a large-diameter flange portion 11b that protrudes radially outward from the small-diameter portion 11a at one end in an axial direction of the small-diameter portion 11a. The flange portion 11b is formed having an outer diameter dimension that is the same as or greater than those of the insulating washer 8 and the metal washer 6.

The small-diameter portion 11a of the collar 11 is inserted into the counterbore 12 provided in the through-hole 41b inside the basal-end wall 41 (the opposite side from the tool attachment surface 2a) and a distal end of the small-diameter portion 11a is brought into close contact with a counterbore surface 12a. At an end surface on a flange portion 11b side of the collar 11, the insulating washer 8 and the metal washer 6 are disposed in a stacked manner in the thickness direction in this order.

It is preferable that the insulating cover 10 be elastically deformable, and the insulating cover 10 is formed from, for example, a sponge. The insulating cover 10 has an annular plate-shaped flat portion 10a that is disposed inside the basal-end wall 41 and a cylindrical tube portion 10b that vertically extends from the flat portion 10a at a center of the flat portion 10a and that is fitted to the hollow hole 41a. In the tube portion 10b, a hollow hole 10c through which the umbilical member A passes is formed so as to extend therethrough in the axial direction.

It is preferable that the tube portion 10b close off a cylindrical gap between an inner circumferential surface of the hollow hole 41a and an outer circumferential surface of the umbilical member A. For example, the tube portion 10b has an inner diameter that is smaller than an outer diameter of the umbilical member A and an outer diameter that is greater than an inner diameter of the hollow hole 41a and is elastically contractible in the radial direction. In this case, an outer circumferential surface of the tube portion 10b comes into contact with the inner circumferential surface of the hollow hole 41a and an inner circumferential surface of the tube portion 10b comes into contact with the outer circumferential surface of the umbilical member A, and thus, the above-described gap is closed off.

In addition, the insulating cover 10 includes a plurality of through-holes 13 that are disposed at positions that correspond to the through-holes 41b of the bracket body 4 when the tube portion 10b is fitted to the hollow hole 41a from inside the bracket body 4.

Each of the through-holes 13 of the insulating cover 10 is configured to have a two-step structure (stepped shape) including: a small-diameter hole 13a into which the small-diameter portion 11a of the collar 11 is inserted; and a large-diameter hole 13b to which the flange portion 11b of the collar 11 is fitted.

The large-diameter hole 13b of the through-hole 13 has a slightly smaller inner diameter dimension than the outer diameter dimensions of the flange portion 11b of the collar 11 to be fitted thereto, the insulating washer 8, and the metal washer 6. In addition, the length dimension in the axial direction of the small-diameter hole 13a of the insulating cover 10 is set to be slightly greater than a dimension in which the depth dimension of the counterbore 12 of the bracket body 4 is subtracted from the length dimension of the small-diameter portion 11a of the collar 11. In addition, the length dimension in the axial direction of the large-diameter hole 13b of the insulating cover 10 is set to be equivalent to a dimension in which the thickness dimension of the flange portion 11b of the collar 11, the thickness dimension of the insulating washer 8, and the thickness dimension of the metal washer 6 are added up.

The operation of the thus-configured bracket 1 and robot 20 according to this embodiment will be described below.

In order to attach the bracket 1 according to this embodiment to the robot 20, first, the umbilical member A taken out from the hollow portion 2d of the arm member 2b of the robot 20 is made to pass through the hollow hole 9a of the insulating plate 9. Next, the umbilical member A that has passed through the hollow hole 9a of the insulating plate 9 is made to pass through the hollow hole 41a provided in the basal-end wall 41 of the bracket body 4 and is taken out into the interior of the bracket body 4.

In addition, the insulating cover 10 is inserted inside the bracket body 4 from the window 43a of the side wall 43 of the bracket body 4 and the umbilical member A taken out into the interior of the bracket body 4 is made to pass through the hollow hole 10c of the inserted insulating cover 10. Then, the tube portion 10b of the insulating cover 10 is fitted to the hollow hole 41a of the bracket body 4. Accordingly, the flat portion 10a of the insulating cover 10 is disposed so as to cover the inner surface of the basal-end wall 41 of the bracket body 4.

In addition, the tube portion 10b of the insulating cover 10 elastically deforms in the radial direction, the inner circumferential surface of the tube portion 10b comes into close contact with the outer circumferential surface of the umbilical member A, and the outer circumferential surface of the tube portion 10b comes into close contact with the hollow hole 41a. Accordingly, the gap between the umbilical member A and the hollow hole 41a of the bracket body 4 is sealed by the insulating cover 10.

In addition, the collar 11, the insulating washer 8, and the metal washer 6 are inserted into each of the through-holes 13 of the insulating cover 10 in this order, the small-diameter portion 11a of the collar 11 is inserted into the counterbore 12 provided in the through-hole 41b of the bracket body 4, and the distal end of the collar 11 is abutted to the counterbore surface 12a. When the distal end of the small-diameter portion 11a of the collar 11 abuts the counterbore surface 12a, the length dimension from the inner surface of the basal-end wall 41 of the bracket body 4 to the flange portion 11b of the collar 11 becomes slightly smaller than the length dimension of the small-diameter hole 13a of the through-hole 13 of the insulating cover 10. Accordingly, the insulating cover 10 is sandwiched between the inner surface of the basal-end wall 41 of the bracket body 4 and the flange portion 11b of the collar 11.

In addition, when the collar 11 is inserted into the through-hole 13 of the insulating cover 10, an outer circumferential surface of the flange portion 11b of the collar 11 is disposed, due to the elasticity of the insulating cover 10, in a close contact state with an inner circumferential surface of the large-diameter hole 13b of the through-hole 13. In addition, when the insulating washer 8 and the metal washer 6 are fitted to the through-hole 13, outer circumferential surfaces of the insulating washer 8 and the metal washer 6 are disposed, due to the elasticity of the insulating cover 10, in a close contact state with the inner circumferential surface of the large-diameter hole 13b of the through-hole 13.

In this state, the insulating plate 9 is disposed at the tool attachment surface 2a of the arm member 2b at the position at which the hollow hole 9a faces the opening of the hollow portion 2d and the through-holes 9b face the screw holes 2c. Then, the bolts 5 in the state of being fitted to the inner holes of the insulating sleeves 7 are inserted into, together with the insulating sleeves 7, the inner holes of the metal washers 6, the insulating washers 8, and the collars 11, and the through-holes 41b and are fastened to the screw holes 2c provided in the tool attachment surface 2a.

Accordingly, axial forces of the bolts 5 are transmitted to the basal-end wall 41 of the bracket body 4 via the metal washers 6, the insulating washers 8, and the collars 11 and the basal-end wall 41 of the bracket body 4 is fixed to the tool attachment surface 2a of the arm member 2b with the insulating plate 9 sandwiched therebetween.

The tool attachment surface 2a of the arm member 2b and the robot attachment surface 4a of the bracket body 4 are electrically insulated from each other as a result of the insulating plate 9 being sandwiched therebetween.

In addition, because the bolts 5 are fastened to the screw holes 2c provided in the tool attachment surface 2a of the arm member 2b, the bolts 5, the metal washers 6, and the arm member 2b are electrically connected with each other. In addition, because the collars 11 are in close contact with the counterbore surfaces 12a of the counterbores 12 provided in the basal-end wall 41 of the bracket body 4, the collars 11 are electrically connected with the bracket body 4.

In contrast, the outer circumferential surfaces of the bolts 5 and the inner surfaces of the inner holes of the collars 11, as well as the outer circumferential surfaces and the inner surfaces of the through-holes 41b of the bracket body 4, are electrically insulated from each other by the insulating sleeves 7, and the metal washers 6 and the collars 11 are electrically insulated from each other by the insulating washers 8. Therefore, the bolts 5 and the metal washers 6 are electrically insulated from the bracket body 4 and the collars 11, and thus, the bracket body 4 and the robot body 2 are electrically insulated from each other.

The tool 3 is attached to the tool attachment surface 4b of the bracket body 4 fixed to the tool attachment surface 2a. In the case in which the tool 3 has a hollow structure, the umbilical member A is pulled into the interior of the bracket body 4 from the opening of the hollow portion 2d of the arm member 2b at the distal end and is connected to the tool 3 via the window 42a of the distal-end wall 42. In the case in which the tool 3 does not have a hollow structure, the umbilical member A is pulled out to the exterior of the bracket body 4 from the interior of the bracket body 4 via the window 43a of the side wall 43 and is connected to the tool 3.

In the case in which the tool 3 is for, for example, welding, a current output from the tool 3 could potentially flow into the bracket body 4. With this embodiment, because the bracket body 4 and the robot body 2 are insulated from each other, it is possible to prevent the current from flowing into the robot body 2 from the bracket body 4.

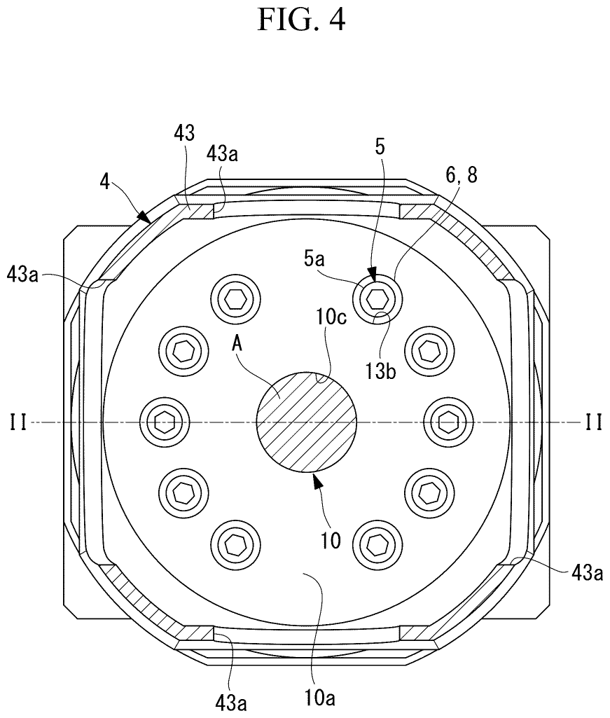

In addition, as shown in FIGS. 4 and 5, in the state in which the bracket body 4 is fixed to the tool attachment surface 2a, the inner surface of the basal-end wall 41 of the bracket body 4 having a hollow structure is nearly entirely covered with the insulating cover 10, including the gap between the umbilical member A and the hollow hole 41a. Only heads 5a of the plurality of bolts 5 and the metal washers 6 are exposed without being covered with the insulating cover 10. In the case in which the tool 3 is for welding, foreign matter such as spatter generated during welding could potentially also attach to the interior of the bracket body 4.

In this case, the surfaces of the collars 11 that are electrically connected with the bracket body 4 are not exposed by being covered, without a gap, with the large-diameter holes 13b of the through-holes 13 of the insulating cover 10 and the insulating washers 8. Furthermore, with the bracket 1 and the robot 20 according to this embodiment, outer circumferential surfaces of the flange portions 11b of the collars 11 and outer circumferential surfaces of the insulating washers 8 are fitted to the large-diameter holes 13b of the through-holes 13 of the insulating cover 10 in a close contact state. Therefore, even if foreign matter, such as spatter, is attached to the heads 5a of the bolts 5 and the metal washers 6 that are exposed from the insulating cover 10, the electrical insulation properties in regions B between the collars 11 and the bolts 5 or the metal washers 6 do not deteriorate.

In addition, the tube portion 10b of the insulating cover 10 that covers the hollow hole 41a prevents foreign matter from attaching to the inner circumferential surface of the hollow hole 41a and an inner circumferential surface of the hollow portion 2d. Accordingly, it is possible to prevent the inner circumferential surface of the hollow hole 41a from becoming electrically connected with the inner circumferential surface of the hollow portion 2d in a region C.

In addition, in the case in which the insulating cover 10 is elastically deformable, because the insulating cover 10 comes into close contact with the outer circumferential surface of the umbilical member A and the inner circumferential surface of the hollow hole 41a due to the elastic restoring force, it is possible to more reliably prevent the intrusion of foreign matter, such as spatter. Therefore, the deterioration of the electrical insulation properties between the bracket body 4 and the robot body 2 is more reliably prevented.

In particular, in the case in which the inner surface of the bracket body 4 is uneven, for example, in the case in which the inner surface is a cast surface, deformation of the flat portion 10a in conformity to an uneven shape of the inner surface of the basal-end wall 41 prevents gap formation between the flat portion 10a and the inner surface of the basal-end wall 41. Accordingly, it is possible to reliably close off, by the insulating cover 10, sites that could be entrances through which foreign matter intrudes into the regions B and C.

In addition, with this embodiment, because the bracket body 4 is electrically insulated from the robot body 2, electrical insulation is not necessary between the bracket body 4 and the tool 3. Therefore, an operator can attach the tool 3 to the tool attachment surface 4b and detach the tool 3 therefrom without the need to perform an additional work to ensure electrical insulation between the tool 3 and the robot body 2.

It is also possible to prevent a current from flowing into the robot body 2 from the tool 3 by providing an insulation member between the bracket body 4 and the tool 3. However, in that case, the insulation member also needs to be attached and detached when attaching the tool 3 to the tool attachment surface 4b and detaching the tool 3 therefrom, and thus, the number of components and work to be handled increase.

In addition, with this embodiment, the bracket 1 itself is provided with the insulation structure that insulates the bracket 1 from the robot body 2 and the bracket 1 is fixed to the tool attachment surface 2a separated therefrom only by the thin insulating plate 9. Accordingly, it is possible to suppress the offset amount from the tool attachment surface 2a to the tool attachment surface 4b, the total weight of the members to be attached to the tool attachment surface 2a, and the costs.

It is also possible to electrically insulate the bracket 1 from the robot body 2 by disposing an insulation member between the tool attachment surface 2a and the bracket 1 and by fixing the bracket 1 to the insulation member instead of the tool attachment surface 2a. However, in that case, a thick insulation member is required, and thus, the offset amount, the total weight, and the costs increase.

As has been described above, simply by fastening the bolts 5 to the screw holes 2c of the tool attachment surface 2a, the bracket body 4 can be fixed to the tool attachment surface 2a in an electrically insulated state and the insulating cover 10 can be attached to the bracket body 4. Therefore, it is possible to perform the attachment of the bracket 1 to the arm member 2b and the attachment of the insulating cover 10 to the bracket body 4 in one step, and thus, there is an advantage in that it is possible to reduce the number of fixing members and the complexity of the fixing work.

Note that, in this embodiment, although the insulating sleeves 7 and the insulating washers 8 are separately provided, the components may integrally be formed. In addition, the insulating plate 9 may be provided as part of the robot body 2 or part of the bracket body 4. In addition, the insulating plate 9 may integrally be formed with the insulating sleeves 7.

In addition, as a result of disposing the metal washers 6 having the same outer diameter dimensions as the insulating washers 8 so as to be stacked on the insulating washers 8, forces received from the heads 5a of the bolts 5 can be dispersed over the entire surfaces of the insulating washers 8 by the metal washers 6, and thus, it is possible to prevent the insulating washers 8 from being broken due to stress concentration. Alternatively, the metal washers 6 may be omitted in the case in which the insulating washers 8 are formed from a material having a sufficient strength.

In addition, in the above-described embodiment, a configuration in which the collars 11 are fitted to the counterbores 12 of the bracket body 4 may be employed and the bracket body 4 and the arm member 2b may be aligned by pins or the like.

In this case, because gaps are formed between the through-holes 41b of the bracket body 4 and the outer circumferential surfaces of the bolts 5, as well as between the inner holes 11c of the collars 11 and the outer circumferential surfaces, the insulating sleeves 7 may be omitted.

In addition, in the above-described embodiment, although the insulating cover 10 has the tube portion 10b that covers the inner circumferential surface of the hollow hole 41a, in the case in which it is possible to cover the hollow hole 41a only with the flat portion 10a, the insulating cover 10 may not necessarily have the tube portion 10b.

Specifically, in the case in which an inner circumferential surface of the flat portion 10a is in contact with the outer circumferential surface of the umbilical member A and the gap between the inner circumferential surface of the hollow hole 41a and the outer circumferential surface of the umbilical member A is closed off by the flat portion 10a, it is possible to prevent, only by the flat portion 10a, foreign matter from intruding into the hollow hole 41a. Therefore, in such a case, the tube portion 10b may be omitted.

In addition, in the above-described embodiment, the insulating cover 10 may not necessarily be elastically deformable. For example, the insulating cover 10 may be formed from a rigid material.

In the case in which the insulating cover 10 is an elastically deformable member, such as a sponge, even if the lengths of the small-diameter holes 13a of the through-holes 13 are not strictly set, it is possible to achieve both the fixing of the insulating cover 10 and the fixing of the bracket 1 to the arm member 2b due to the elastic deformation of the insulating cover 10.

In addition, in the case in which the insulating cover 10 is an elastically deformable member, such as a sponge, the insulating cover 10 can easily be inserted into the bracket body 4 from the window 43a. On the other hand, in the case in which the insulating cover 10 is not elastically deformable, it could be difficult to make the insulating cover 10 pass through the window 43a. In this case, the insulating cover 10 may be divided into a plurality of members having dimensions that allow the members to pass through the window 43a.

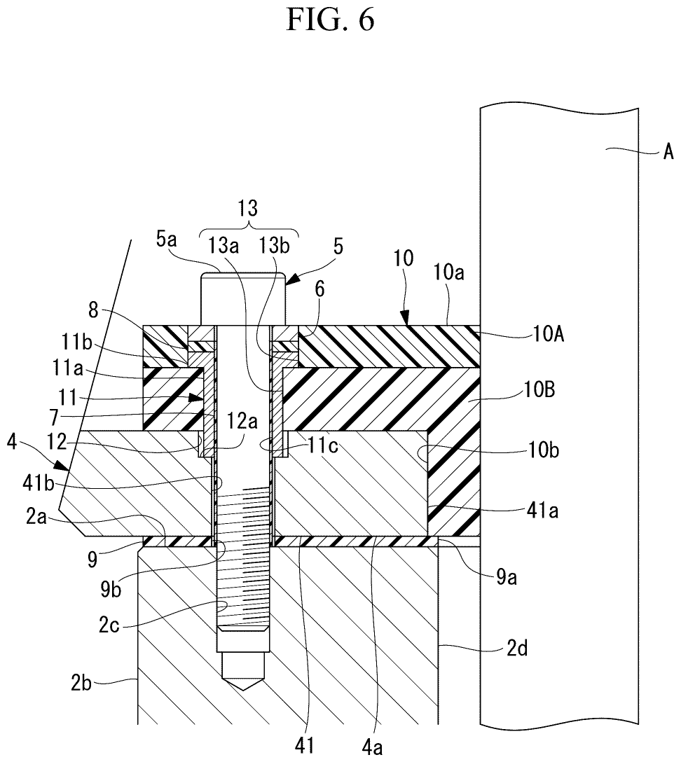

In addition, in this embodiment, the single-piece insulating cover 10 has the through-holes 13 having the two-step structure including the small-diameter holes 13a and the large-diameter holes 13b. Alternatively, as shown in FIG. 6, the insulating cover 10 may be divided into two in the thickness direction, large-diameter holes (second through-holes) 13b may be provided in an insulating cover (second cover) 10A, which is one of the divided insulating covers, and small-diameter holes (first through-holes) 13a may be provided in an insulating cover (first cover) 10B, which is the other divided insulating cover. Then, by combining the two insulating covers 10A and 10B in a stacked state, the through-holes 13 having the two-step structure as in FIG. 5 are formed.

In this case, the two insulating covers 10A and 10B may be fixed in the stacked state with respect to each other by means of bonding or the like. Accordingly, it suffices that each of the insulating covers 10A and 10B includes through-holes having uniform diameter dimensions, the diameter dimensions being different between the insulating covers 10A and 10B; therefore, processing thereof is easy.

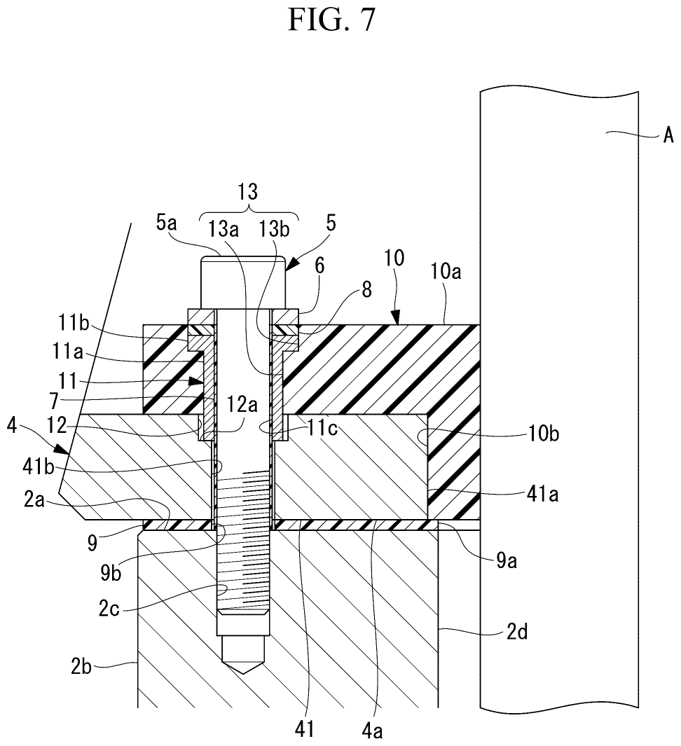

In addition, in this embodiment, the flange portions 11b of the collars 11, the insulating washers 8, and the metal washers 6 are fitted to, in a stacked state, the large-diameter holes 13b of the through-holes 13 provided in the insulating cover 10. Alternatively, as shown in FIG. 7, the metal washers 6 may be exposed outside the large-diameter holes 13b. By doing so also, it is possible to prevent, by the insulating washers 8, the deterioration of the electrical insulation properties between the metal washers 6 and the collars 11 due to adhesion of spatters or the like.

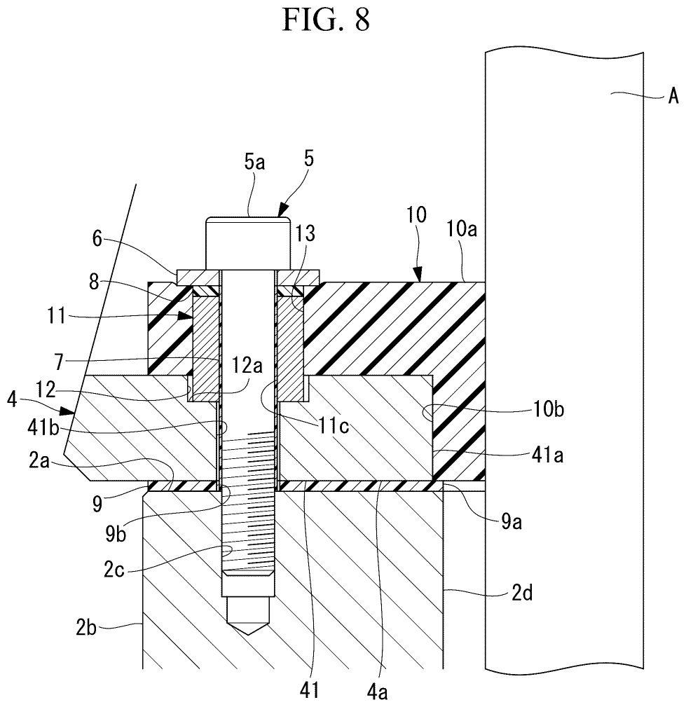

In addition, in this case, as shown in FIG. 8, the metal washers 6 may be configured so as to hold down the surface of the insulating cover 10 by setting the outer diameter dimensions of the metal washers 6 to be sufficiently greater than the inner diameter dimensions of the through-holes 13. Accordingly, the insulating cover 10 does not need to be held down by the flange portions 11b of the collars 11; therefore, it is possible to facilitate manufacturing of the insulating cover 10 and the collars 11 by configuring the collars 11 in a simple cylindrical shape and the through-holes 13 as holes having a simple circular cross-section with a single inner diameter dimension.

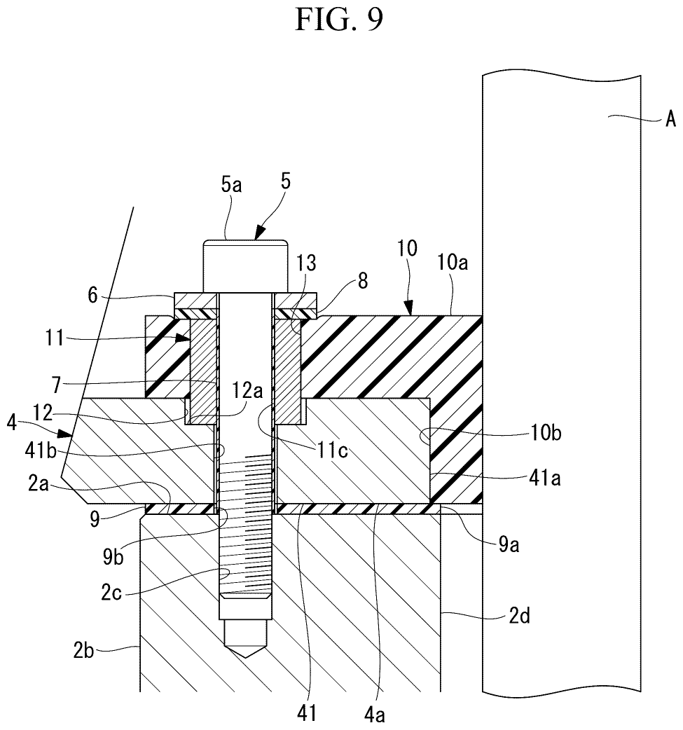

In addition, instead of holding down the insulating cover 10 by the metal washers 6, the insulating washers 8 may be configured to have outer diameter dimensions that are equivalent to those of the metal washers 6 and that are greater than the inner diameter dimensions of the through-holes 13, as shown in FIG. 9. Accordingly, the insulating cover 10 can be held down by the insulating washers 8 and, in this way also, it is possible to simplify the shapes of the insulating cover 10 and the collars 11.

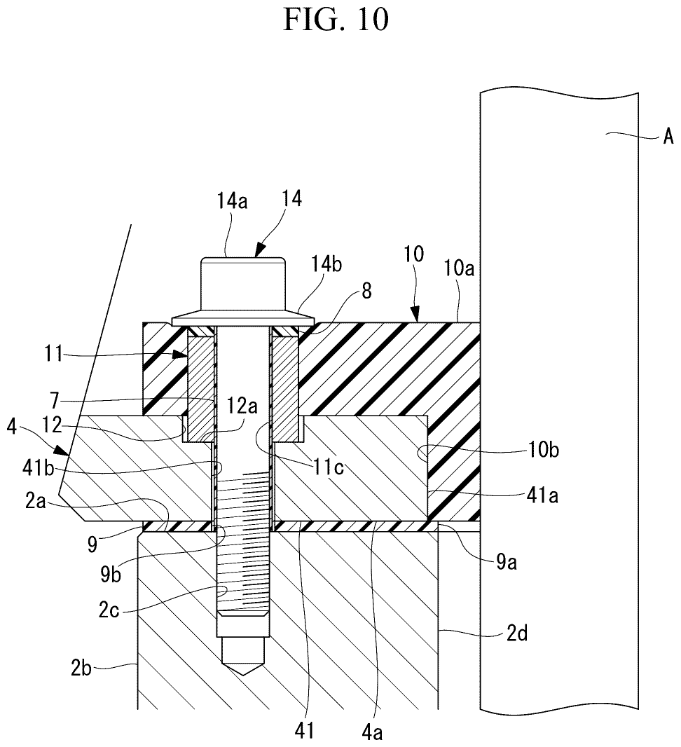

In addition, instead of employing the bolts 5 and the metal washers 6, flanged bolts 14 in which heads 14a and flanges 14b of bolts are integrally formed may be employed as the bracket fixing implements, as shown in FIG. 10. The flanges 14b of the flanged bolts 14 can hold down the insulating cover 10 while closing off the through-holes 13.

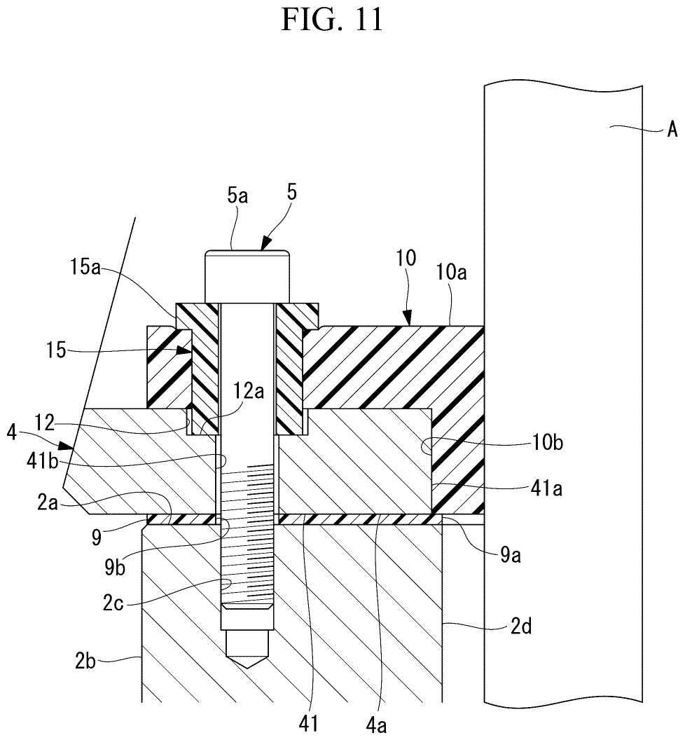

In addition, in this embodiment, although the collars 11 formed from a high strength material, for example, steel, are employed, so long as a sufficient strength is ensured, collars 15 formed from a material having electrical insulation properties may be employed. For example, as shown in FIG. 11, employing collars 15 provided with flanges 15a makes the insulating washers 8, the insulating sleeves 7, and the metal washers 6 unnecessary, and thus, it is possible to enhance the ease of manufacturing by also simplifying the shapes of the through-holes 13 of the insulating cover 10.

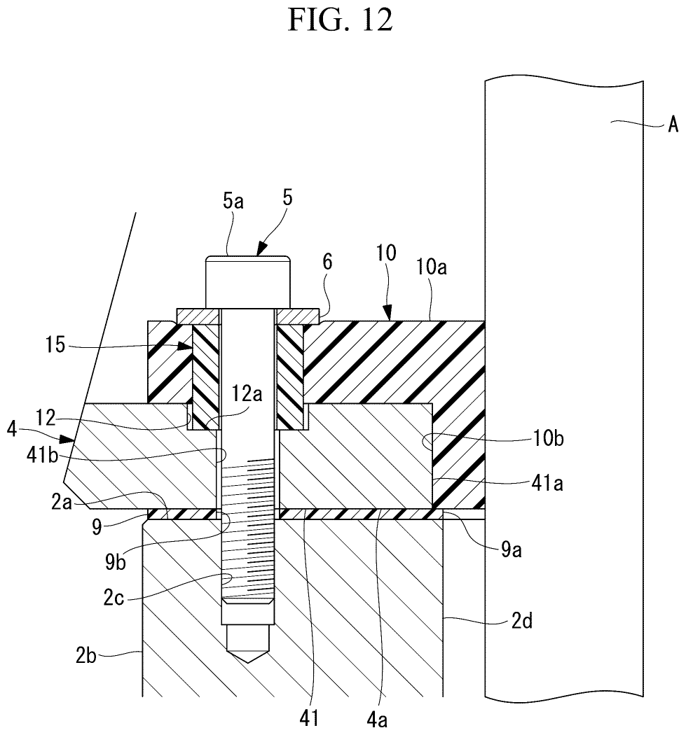

In addition, as shown in FIG. 12, by combining with the metal washers 6, the collars 15 formed from a material having electrical insulation properties can also be formed in a simple cylindrical shape.

In addition, although the counterbores 12 into which the collars 11 or 15 are inserted are provided in the inner surface of the bracket body 4, alternatively, the counterbores 12 to which the distal ends of the collars 11 or 15 are abutted may be omitted, if the inner surface of the bracket body 4 is configured as a machine processed seat.

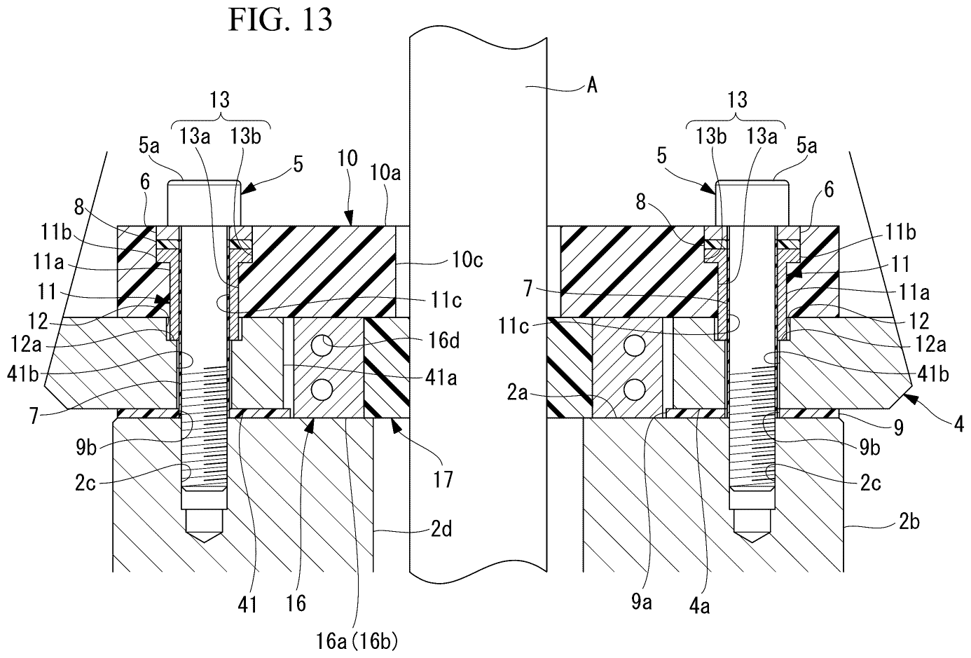

In addition, in the above-described embodiment, as shown in FIG. 13, the bracket 1 may additionally include an annular clamp 16 that is disposed in the hollow hole 41a and that fixes the umbilical member A with respect to the tool attachment surface 2a.

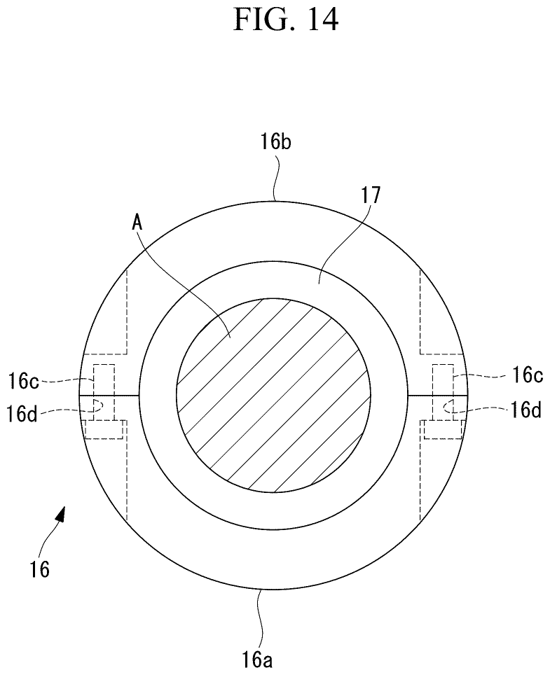

The clamp 16 has, as shown in FIG. 14, two semi-arc-shaped components 16a and 16b that sandwich the umbilical member A in the radial direction. An elastic body 17 is wound around the outer circumferential surface of the umbilical member A and the elastic body 17 is disposed between the umbilical member A and the clamp 16.

The two components 16a and 16b are fixed in close contact with the outer circumferential surface of the umbilical member A separated therefrom by the elastic body 17. The components 16a and 16b are fixed, for example, by screwing bolts 16c into bolt holes 16d of the components 16a and 16b. The clamp 16 is fixed to the tool attachment surface 2a by bolts (not shown).

In FIG. 13, because a space between the inner circumferential surface of the hollow hole 41a and the outer circumferential surface of the umbilical member A is closed off by the clamp 16 and the elastic body 17, there may be a gap between the hollow hole 10c of the insulating cover 10 and the outer circumferential surface of the umbilical member A and the insulating cover 10 may not have the tube portion 10b. The flat portion 10a extends farther inward in the radial direction than the outer circumferential surface of the clamp 16 and entirely covers inside the clamp 16.

With this configuration, movements of the umbilical member A in the bracket body 4 can be suppressed by fixing the umbilical member A in the hollow hole 41a of the basal-end wall 41.

In addition, in the above-described embodiment, although the bracket 1 is used to attach a hollow or solid tool 3 to the hollow arm member 2b, alternatively, the bracket 1 may be used to attach a hollow tool 3 to an arm member 2b that is not hollow. In this case, the bracket 1 may be provided as part of the welding device. In other words, the welding device according to this embodiment includes the bracket 1 and the hollow welding tool 3.

The hollow welding tool 3 is attached to the robot attachment surface 4a provided with the hollow hole 41a by the bolts 5 and the metal washers 6, and the tool 3 and the bracket body 4 are electrically insulated from each other by the insulating sleeves 7, the insulating washers 8, and the insulating plate 9. At least one umbilical member A is routed between the hollow portion of the tool 3 and the interior of the bracket body 4 via the hollow hole 41a. The bracket body 4 is attached to the tool attachment surface 2a of the arm member 2b that is not hollow at the tool attachment surface 4b. In this case, the distal-end wall 42 need not have the window 42a and may include through-holes (not shown) instead of the screw holes 42b.

In addition, in the above-described embodiment, the bracket 1 may be provided as part of the welding robot system. In other words, the robot system according to this embodiment includes the robot 20 having the bracket 1 and the robot body 2 and the welding device having the tool 3, such as a welding gun. The welding device is fixed to the distal end of the robot body 2 separated therefrom by the bracket 1.

### REFERENCE SIGNS LIST

1 bracket
2 robot body
2a tool attachment surface
2b arm member at distal end
2c screw hole
2d hollow portion
3 tool, welding tool
4 bracket body
5 bolt (bracket fixing implement)
5a, 14a head
6 metal washer (bracket fixing implement)
8 insulating washer (insulation member)
10, 10A, 10B insulating cover (first cover, second cover)
11, 15 collar
11a small-diameter portion
11b flange portion
13a small-diameter hole (first through-hole)
13b large-diameter hole (second through-hole)
14 flanged bolt (bracket fixing implement)
16 clamp
20 robot
41a hollow hole
41b through-hole
A umbilical member

1. A bracket comprising:
a bracket body that has a hollow structure and that is attached to a tool attachment surface of a hollow arm member with an insulating plate having electrical insulation properties interposed therebetween;
insulation members that electrically insulate bracket fixing implements and fix the bracket body to the tool attachment surface from inside the bracket body, and the bracket body from each other; and
an insulating cover that has electrical insulation properties and that is disposed inside the bracket body, wherein
each of the bracket body, the insulating plate, and the insulating cover has a hollow hole through which an umbilical member passes into an interior of the bracket body from inside the arm member via an opening of the tool attachment surface,
the bracket fixing implements include one or more bolts that are fastened to screw holes provided in the tool attachment surface by passing through through-holes provided in each of the bracket body, the insulating plate, and the insulating cover, and
the insulating cover covers a gap between the hollow hole of the bracket body and the umbilical member and is fixed to the bracket body by fastening the bolts.

2. The bracket according to claim 1, further comprising cylindrical collars that are disposed in the through-holes of the insulating cover, through which the respective bolts pass, and that are sandwiched in an axial direction between heads of the respective bolts and the bracket body, wherein
the insulation members include insulating washers that are sandwiched between ends of the collars on one side thereof in the axial direction and the heads of the bolts and that are brought into close contact with inner circumferential surfaces of the through-holes of the insulating cover over an entire circumference of the through-holes.

3. The bracket according to claim 1, wherein the insulation members include cylindrical collars that have electrical insulation properties, that are disposed in the through-holes of the insulating cover, through which the respective bolts pass, and that are sandwiched in an axial direction between heads of the respective bolts and the bracket body.

4. The bracket according to claim 1, wherein the insulating cover is elastically deformable.

5. The bracket according to claim 1, further comprising an annular clamp that is disposed in the hollow hole and that fixes the umbilical member with respect to the tool attachment surface.

6. The bracket according to claim 2, wherein:
the collars include small-diameter portions and flange portions that protrude outward in a radial direction from ends of the small-diameter portions on one side; and
the through-holes of the insulating cover have a stepped shape in which outer circumferential surfaces of the small-diameter portions of the collars and outer circumferential surfaces of the flange portions of the collars are respectively fitted to the through-holes.

7. The bracket according to claim 6, wherein the insulating cover is configured by stacking a first cover that has first through-holes to which the outer circumferential surfaces of the small-diameter portions of the collars are fitted and a second cover that has second through-holes to which the outer circumferential surfaces of the flange portions of the collars are fitted.

8. A robot comprising:
a robot body that has at least one arm member and in which the arm member at a distal end thereof is hollow; and
the bracket according to claim 1.

9. A welding device comprising:
the bracket according to claim 1; and
a hollow welding tool, wherein
the welding tool is attached to an outer surface of the bracket body, the outer surface being provided with the hollow hole, and at least one umbilical member is routed between a hollow portion of the welding tool and the interior of the bracket via the hollow hole.

10. (canceled)
